(19) United States
(12) Patent Application Publication
(10) Pub. No.: US 2021/0279065 A1
(43) Pub. Date: Sep. 9, 2021

(54) LIGHTWEIGHT MEMORY ORDERING PRIMITIVES

(71) Applicant: Advanced Micro Devices, Inc., Santa Clara, CA (US)

(72) Inventors: Nuwan Jayasena, Santa Clara, CA (US); Shaizeen Aga, Santa Clara, CA (US); Anirban Nag, Santa Clara, CA (US)

(73) Assignee: Advanced Micro Devices, Inc., Santa Clara, CA (US)

(21) Appl. No.: 16/808,346

(22) Filed: Mar. 3, 2020

(51) Int. Cl. G06F 9/38

(52) U.S. Cl. CPC G06F 9/3842

(57) ABSTRACT

Techniques are provided for performing memory operations. The techniques include issuing, by a processor, a fence primitive to a memory system, the fence primitive issued in a manner that indicates a program order of memory operation execution.

### BACKGROUND

Modern memory systems frequently execute memory operations out of order. A memory fence is a construct that can be used by a programmer to enforce memory ordering. Some current implementations of memory fences introduce certain drawbacks. Therefore, a better memory fence implementation is desirable.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 is a block diagram of an instruction execution pipeline, located within the processor of FIG. 1;

FIG. 3 illustrates a load/store pipeline according to an example;

FIGS. 4A-4G illustrate an example sequence of states for processing load/store operations including a fence primitive;

FIGS. 5A-5F illustrate an example of processing load/store operations at memory system phases that include a branching path and a branch reconvergence stage; and

FIG. 6 is a flow diagram of a method for ordering memory operations according to a fence primitive, according to an example.

### DETAILED DESCRIPTION

Techniques are provided for performing memory operations. The techniques include issuing, by a processor, a fence primitive to a memory system, the fence primitive issued in a manner that indicates a program order of memory operation execution.

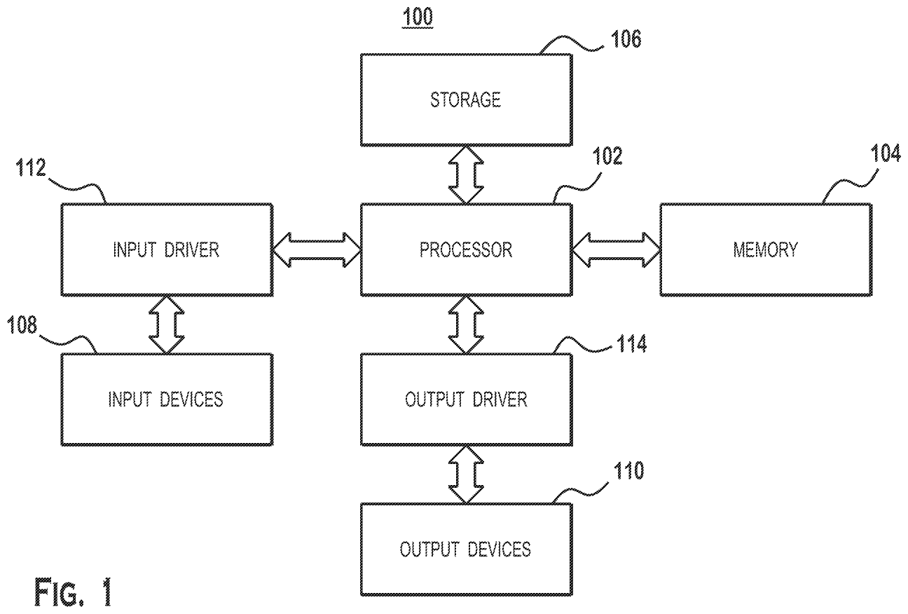

FIG. 1 is a block diagram of an example device 100 in which aspects of the present disclosure are implemented. The device 100 includes, for example, a computer, a gaming device, a handheld device, a set-top box, a television, a mobile phone, or a tablet computer. The device 100 includes a processor 102, a memory 104, a storage device 106, one or more input devices 108, and one or more output devices 110. The device 100 may also optionally include an input driver 112 and an output driver 114. It is understood that the device 100 may include additional components not shown in FIG. 1.

The processor 102 includes, for example, a central processing unit (CPU), a graphics processing unit (GPU), a CPU and GPU located on the same die, or one or more processor cores, wherein each processor core is a CPU or a GPU. The memory 104 may be located on the same die as the processor 102 or may be located separately from the processor 102. The memory 104 includes, for example, a volatile or non-volatile memory, for example, random access memory (RAM), dynamic RAM, or a cache.

The storage device 106 includes, for example, a fixed or removable storage, for example, a hard disk drive, a solid-state drive, an optical disk, or a flash drive. The input devices 108 include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108 and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

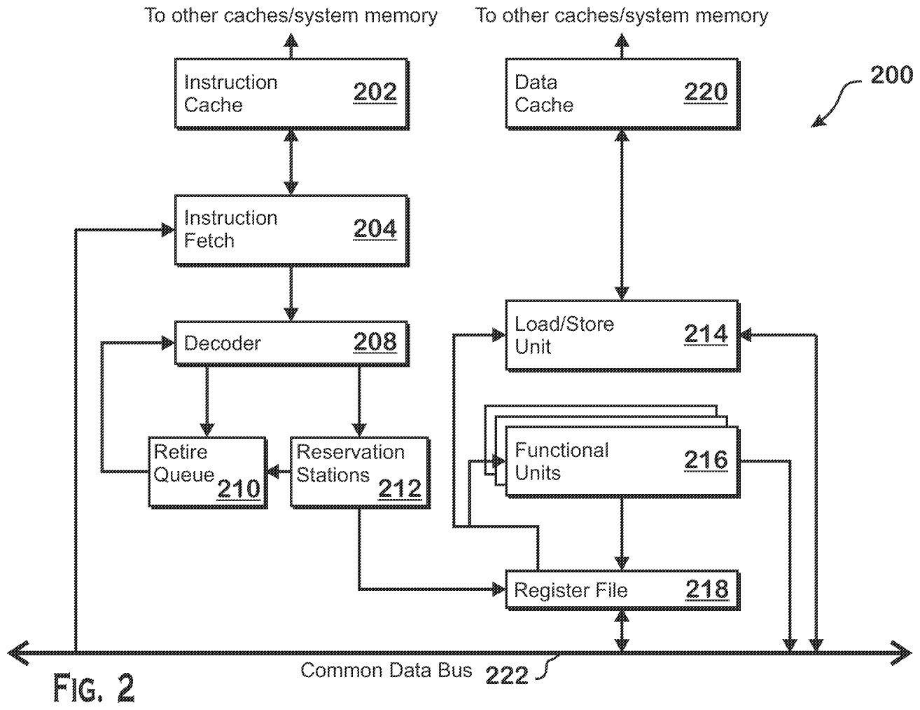

FIG. 2 is a block diagram of an instruction execution pipeline 200 located within the processor 102 of FIG. 1. Although one specific configuration for an instruction execution pipeline 200 is illustrated, it should be understood that a wide variety of instruction execution pipelines fall within the scope of the present disclosure. The instruction execution pipeline 200 retrieves instructions from memory and executes the instructions, outputting data to memory and modifying the state of elements associated with the instruction execution pipeline 200, such as registers within register file 218.

The instruction execution pipeline 200 includes an instruction fetch unit 204 that fetches instructions from system memory (such as memory 104) using an instruction cache 202, a decoder 208 that decodes fetched instructions, functional units 216 that perform calculations to process the instructions, a load store unit 214, that loads data from or store data to system memory via a data cache 220, and a register file 218, which includes registers that store working data for the instructions.

The decoder 208 generates micro-operations and dispatches the micro-operations to the retire queue 210. Note, herein the term “instructions,” when referring to instructions after decoding, is sometimes used interchangeably with the term “micro-operations.” In other words, it is sometimes stated that a particular unit past the decoder stage 208 performs certain actions with respect to instructions, and in these instances, the word “instruction” refers to the micro-operations output by the decoder stage 208.

A retire queue 210 tracks instructions that are currently in-flight and ensures in-order retirement of instructions despite allowing out-of-order execution while in-flight. The term “in-flight instructions” refers to instructions that have been received by the retire queue 210 but have not yet retired. Retirement occurs when an instruction has completed (performed all operations in the functional units 216 and/or load/store unit 214) and is not or no longer executing speculatively. Reservation stations 212 maintain in-flight instructions and track instruction operands. When all operands are ready for execution for a particular instruction, reservation stations 212 send the instruction to a functional unit 216 or a load/store unit 214 for execution. Completed instructions are marked for retirement in the retire queue 210 and are retired when at the head of the retire queue 210. Retirement refers to the act of committing results of an instruction to the architectural state of the processor. It is possible, for example, for instructions to execute speculatively and out of order. If speculation fails, the instruction does not retire and is instead flushed from the pipeline 200. At point of retirement, an instruction is, in most cases, considered to no longer be speculatively executing, and thus results of that instruction are “committed” to the state of the pipeline 200.

Various elements of the instruction execution pipeline 200 communicate via a common data bus 222. For example, the functional units 216 and load/store unit 214 write results to the common data bus 222 which may be read by reservation stations 212 for execution of dependent instructions and by the retire queue 210 as the final processing result of an in-flight instruction that has finished execution. The load/store unit 214 also reads data from the common data bus 222. For example, the load/store unit 214 reads results from completed instructions from the common data bus 222 and writes the results to memory via the data cache 220 for store instructions.

FIG. 3 illustrates an example memory operation execution system 300 involved with processing load operations and store operations. The memory operation execution system 300 includes the load/store unit 214 of FIG. 2 as well as a memory system 301. The memory system 301 represents a memory hierarchy that includes one or more memory system phases 302. Each memory system phase 302 is a memory such as a cache level (e.g., level 0 cache, level 1 cache, and so on), or another type of memory of a memory hierarchy (such as random access memory (“RAM”), non-volatile random access memory (“NVRAM”), or other memories). Other example phases 302 include system memory, non-volatile memory, or memory with processing components (processing-in-memory: “PIM.”).

The load/store unit 214 executes load operations, which read data from memory and place the data into registers, as well as store operations, which write data to memory. The load/store unit 214 processes load operations by determining the address from which to load and providing that address, along with an indication that data at that memory address is requested from the memory system 301. The memory system 301 searches the hierarchically organized memory system phases 302 until a hit occurs. A miss occurs in a particular memory system phase 302 if the designated data is not stored in that particular phase 302 (for example, a cache level may not store a cache line associated with a particular memory address). A hit occurs where the designated memory address is stored in a particular phase 302. When a hit occurs, the data requested is returned and execution of the load operation is considered complete.

The load/store unit 214 processes store operations by determining the address at which to store data, and the data to store. Processing store operations also involves the load/store unit 214 transmitting an indication to the memory system 301 that the determined data should be stored at the determined memory location. The memory system 301 searches the hierarchically organized memory system phases 302 until a hit occurs. When the hit occurs, the data requested to be written is written to that memory and execution of the store operation is considered complete.

In addition, the load/store unit 214 is capable of performing memory fence operations that enforce ordering between different memory operations. In general, a fence operation causes execution of memory operations older than the fence operation in program order to appear to software to execute earlier than memory operations younger than the fence operation in program order. In an example, a first load operation is executed, then a fence operation is executed, and then a second load operation is executed. The first load operation is sent to the memory system 301 and misses at phase 1, phase 2, and phase 3. The second load operation is sent to the memory system 301 and hits at phase 1. Because of the fence operation, the memory system 301 executes these load operations in an ordered manner. Specifically, load operations are executed in a manner that appears to software as if the first load operation is executed before the second load operation. This means that portions of the memory system 301 could execute the load operations in an order that does not respect fence ordering, but there is no way for software to detect such execution that does not respect fence ordering.

Note that the above ordering occurs despite the fact that it could be possible for the second load operation to execute before the first load operation. More specifically, the second load operation hits in memory system phase 1 302(1), while the first load operation misses in that phase 302 (1) and does not hit until memory system phase 3 302(3). It therefore could be possible for the second load operation to complete before the first load operation if the ordering is not enforced.

In one technique for implementing fence operations, the load/store unit 214 issues a fence operation and then waits to receive notifications that all loads and stores older than the fence operation have completed before issuing subsequent instructions for execution. In some implementations, such notifications are received from a synchronization point, which is a point in the memory hierarchy that is the limit at which synchronization occurs. In an example, the synchronization point is a level 2 cache and thus the load/store unit 214 waits to receive notifications from the level 2 cache that each of the load or store operations older than the fence have occurred at the level 2 cache before issuing subsequent load or store instructions. In some implementations, the load/store unit 214 issues the subsequent instructions for execution into a buffer that holds those subsequent instructions until the load/store unit 214 receives notifications that all loads and stores older than the fence operation have completed. Once those notifications are received, the load/store unit 214 transmits those subsequent instructions to the first memory system phase 302.

Although the above may be satisfactory in certain situations, a more robust, adaptable technique is provided herein which may be preferred in certain situations. This technique implements fence operations with fence primitives that travel through the memory system 301. Each phase 302 of the memory system 301 that is participating in fencing operations obeys the ordering imposed by the fencing operations. Improvements with respect to the above technique is that fencing can be implemented up to any arbitrary point in the memory system 301 (that is, from the load/store unit 214 to any arbitrary point in the memory system 301), and that the processing pipeline 200 does not need to wait for completion of load or store instructions before issuing loads or stores past a fence.

As described above, memory operation execution system 300 is capable of performing fence operations at the request of the load/store unit 214. A fence operation is specified by an instruction in the program instruction stream. The order of the fence operation in the program indicates the ordering to be imposed on the memory operations.

To perform the fence operations of the exemplary embodiment of the innovation(s) described herein, the load/store unit 214 transmits the fence operation to the memory system 301 in a manner that indicates the order of the fence operation with respect to other memory operations transmitted to the memory system 301. Each phase 302 of the memory system 301 obeys the ordering imposed by the fence operation. This technique frees the execution pipeline 200 from the need to enforce fence ordering by waiting for completion of all operations older than the fence in the memory system 301 before transmitting operations younger than the fence operation to the memory subsystem for execution.

The individual memory system phases 302 enforce fence ordering in compliance with the issued fence operation in any technically feasible manner. In one example, the load/store unit 214 indicates the order of the fence operation with respect to the other memory operations by transmitting the fence operation to the memory system 301 after transmitting all younger memory operations to the memory system 301 and before transmitting all older memory operations to the memory system 301. In this example, the order of the fence operation with respect to the other memory operations is implicit. That is, the order of the fence operation with respect to the other memory operations is specified by the order in which the operations are transmitted to the memory system 301, but there is no explicit ordering information transmitted along with the fence operation and other memory operations that explicitly indicates the ordering. In another example, the load/store unit 214 transmits explicit ordering information to a memory system phase 302, and each memory system phase 302 transmits that explicit ordering information to subsequent memory system phases 302. This represents an explicit ordering technique, where information about ordering is explicitly sent to each memory system phase 302.

For the technique involving implicit ordering information (where each memory system phase 302 receives memory operations in order with respect to the fence primitive), each memory system phase 302 obeys the ordering in the following manner. The memory system phase 302 receives load or store operations and processes them as normal if the memory system phase 302 has not received a fence primitive (referred to herein as “normal” or “unfenced” operations). If the memory system phase 302 has received a fence primitive, then the memory system phase 302 prevents operations younger than the fence (i.e., issued after the fence operation) from being transmitted to subsequent memory system phases 302 until the fence primitive is transmitted to the subsequent memory system phase 302. The memory system phase 302 transmits the fence primitive to the subsequent memory system phase 302 in the situation that all operations older than the fence primitive that the fence primitive is considered to be waiting on have completed and all older operations have been transmitted to the subsequent phase 302 or have completed at the memory system phase 302. The result is that each memory system phase 302 processes received memory operations in the order specified by fence operations and also transmits memory operations to the subsequent memory system phase 302 in a manner that memory system phase 302 is able to process the memory operations in the order implicitly specified by fence operations (without the fence operation explicitly defining the order).

For the technique involving explicit ordering information, each memory system phase 302 obeys the ordering in the following manner. The memory system phase 302 receives load or store operations, specifying the ordering with respect to fence operations. The memory system phase 302 processes these load or store operations as specified by this ordering information. The memory system phase 302 transmits the memory operations that do not finish (i.e., do not hit) in the memory system phase 302 to the next memory system phase 302, along with the ordering information and also transmits the fence primitive to the next memory system phase 302. The memory system phase 302 internally executes the operations out of order provided it appears to software that the operations are executed in order. It is possible for an operation to complete execution at a particular memory system phase 302, in which case the subsequent memory system phases 302 do not need to include such operations in the ordering.

One example of the explicit ordering information that is transmitted is order identification tags transmitted with each memory operation. All memory operations prior to a fence operation in program order get an order identification tag of a particular value and all memory operations subsequent to the fence operation get a different order identification tag that indicate that those memory operations are younger in program order. In some examples, groups of operations between two fence primitives get the same order identification tag. In addition, each fence primitive is provided with an order identification tag that indicates the order identification of the immediately older group of operations and also a count of the number of operations in that group. If an operation completes at a particular memory system phase 302, then that memory system phase 302 decrements the number of operations in the associated group. This ordering information is used by a memory system phase 302 to order the memory operations with respect to the fence primitives. For example, if a memory system phase 302 receives some memory operations of one group, a fence primitive for that group, and some memory operations of a younger group, then the memory system phase 302 is able to ensure that the older operations appear to complete before the younger operations.

A memory system phase 302 is permitted to internally execute operations out of order with respect to the fence primitive, as long as the operations appear to software to execute in order with respect to the fence primitive. The fence-based ordering is therefore enforced between memory system phases 302 but is not necessarily strictly enforced within a memory system phase 302. In an example, a level 0 cache receives a load operation, a fence primitive, and then a store operation. The level 0 cache is permitted to perform certain operations, such as checking whether the level 0 cache contains the data referred to by both the load operation and the store operation in parallel or even out of order, as long as software is unable to detect that any reordering of operations has occurred. The term “software” means the program whose execution triggered generation of the load operation, the fence operation, and the store operation.

The load/store unit 214 has the capability to issue fence primitives of different types. The type of a fence primitive determines the type of the memory operations for which ordering is enforced. In an example, a load-after-load fence primitive prevents load operations younger than the fence primitive from appearing to execute at a memory system phase 302 prior to load operations older than the fence primitive appear to execute at that memory system phase 302. In various other examples, the type of a fence primitive is a load-after-store fence primitive, store-after-load fence primitive, or store-after-store fence primitive.

In addition to specifying the types of operations that the fence primitive operates on, in various implementations, the fence primitive also specifies the memory system phase 302 of the load/store pipeline 300 that is the endpoint of enforcing fence operations. More specifically, it is possible for a fence primitive to specify the specific memory system phases 302 that will obey the fence primitive. Memory system phases 302 later than the specified memory system phases 302 will not obey the fence primitive but memory system phases earlier than the specified memory system phase 302 will obey the fence primitive. In an example, a fence primitive specifies that memory up to a level 2 cache will obey the fence primitives, but memories higher in the hierarchy do not obey the fence primitive.

In some examples, memory system phases 302 branch to multiple subsequent memory system phases 302. This situation is sometimes referred to herein as a branching path. A memory system phase 302 that is capable of issuing operations to multiple different memory system phases 302 is referred to as a branching memory system phase 302. In such examples, a fence primitive is transmitted to each such subsequent memory system phase 302. A memory system phase 302 capable of receiving operations from multiple different immediately previous memory system phases 302 is sometimes referred to herein as a branch convergence memory system phase 302.

A branch convergence memory system phase 302 that receives a fence primitive from one of the previous memory system phase 302 obeys rules with respect to a reconverged fence primitive. A reconvergence memory system phase 302 reconverges fence primitives by collecting the fence primitive from each prior memory system phase 302 that has a copy of that fence primitive and merging all such fence primitives together, thereby generating a reconverged fence primitive.

More specifically, when a memory system phase 302 issues operations and a fence primitive to multiple subsequent memory system phases 302, the memory system phase 302 issues a copy of the fence operation to each of the subsequent memory system phases 302. The reconvergence memory system phase 302 subsequent to those multiple subsequent memory system phases 302 receives each of these copies and reconverges those copies into a reconverged fence primitive.

When a reconvergence memory system phase 302 receives a copy of a fence primitive to be reconverged, the reconvergence memory system phase 302 performs the following tasks. The reconvergence memory system phase 302 performs operations older than any such fence primitive copy as normal. The reconvergence memory system phase 302 does not issue any fence primitive copy to any subsequent stage. Further, the reconvergence memory system phase 302 issues operations younger than the fence primitive to subsequent memory system phases 302 in a manner that indicates that the order of the operations younger than the fence primitive with respect to the fence primitive. In examples where explicit ordering is used, the reconvergence memory system phase 302 issues the younger operations along with an indication that the younger operations are younger than the fence primitive. In examples where implicit ordering is used, the reconvergence memory system phase 302 issues the younger operations only after the reconverged fence primitive has been issued, and issues the fence primitive only after all operations older than the fence primitive that are participating in fence ordering have been issued to the subsequent memory system phase 302.

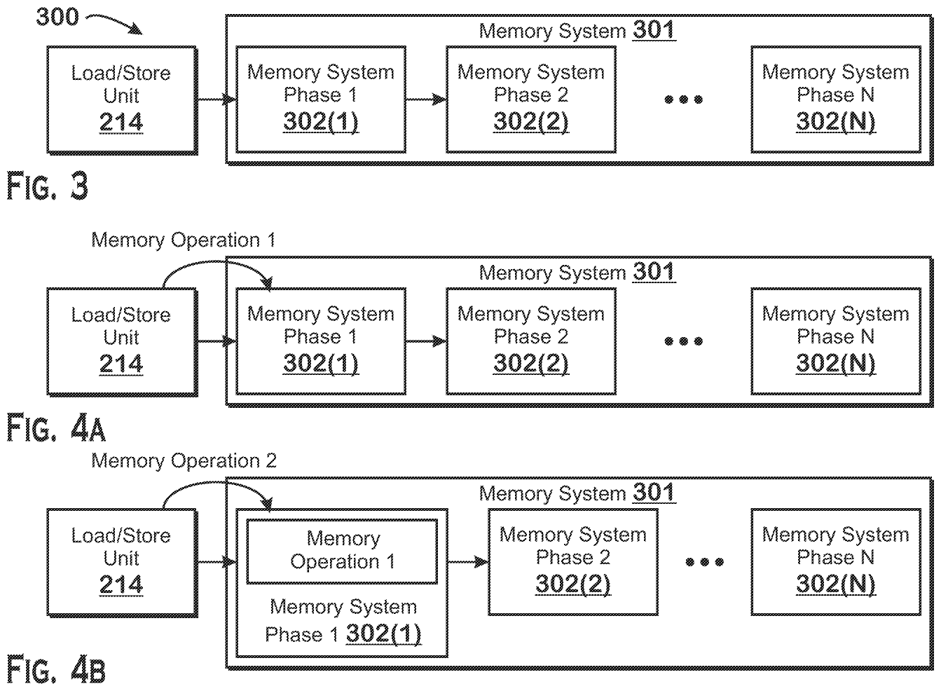

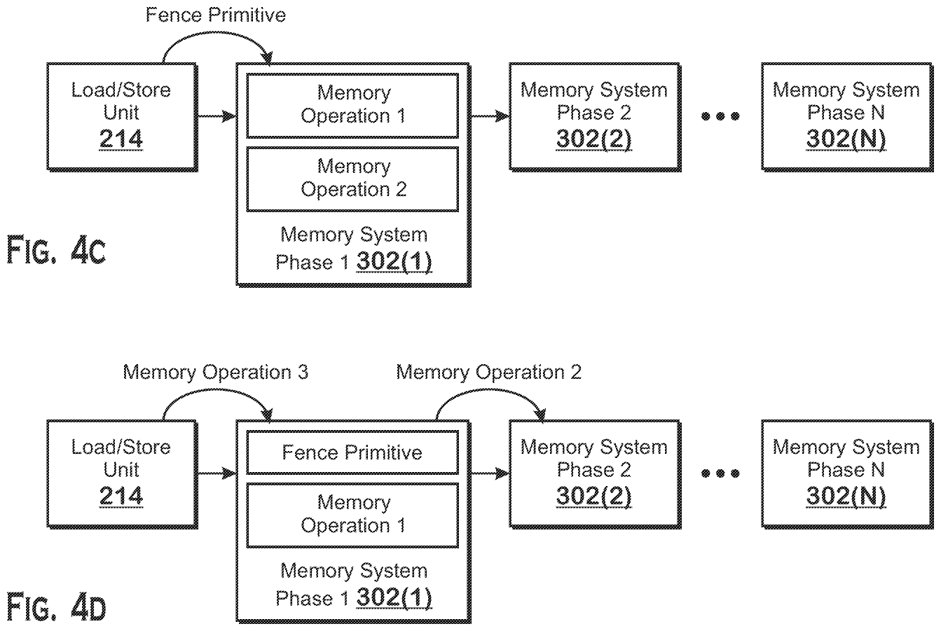

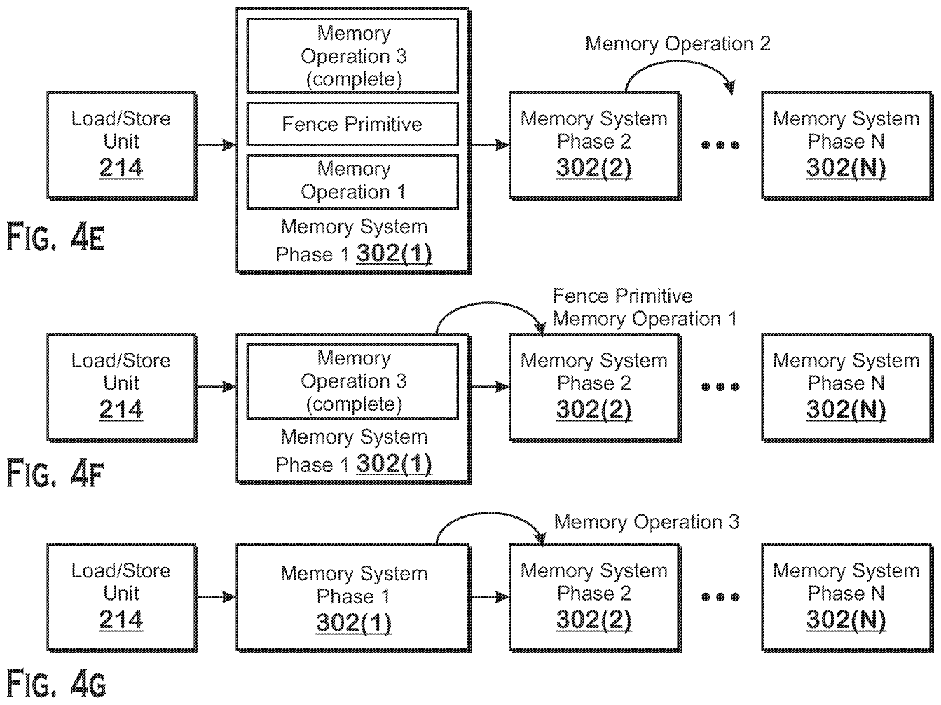

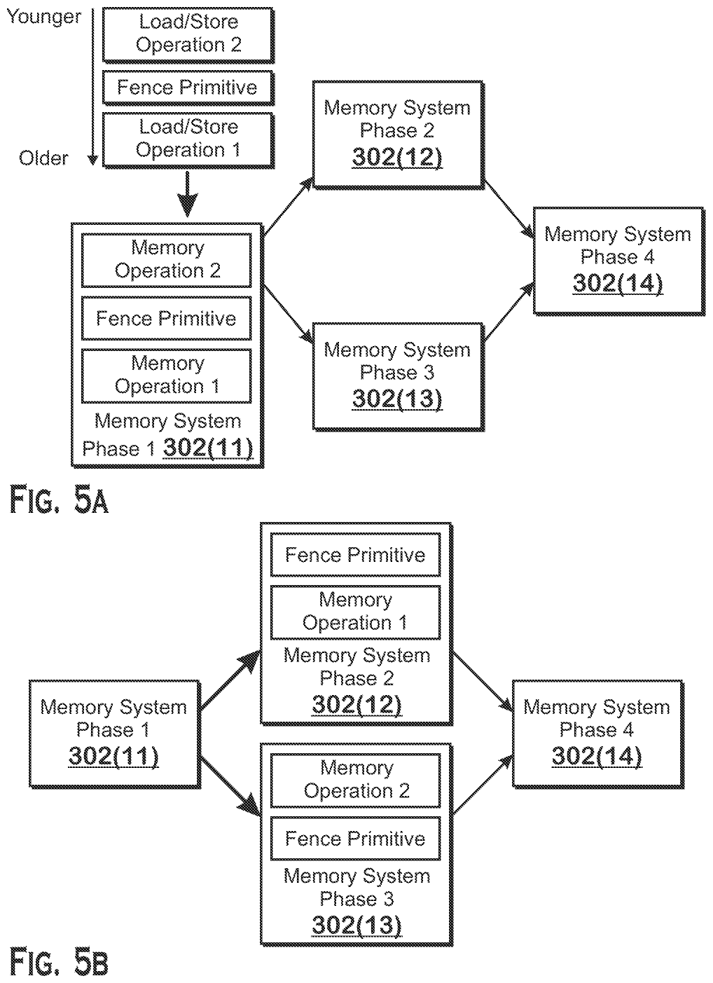

FIGS. 4A-4G illustrate an example sequence of states for processing load/store operations including a fence primitive. In this example, the memory system phases 302 enforce ordering with respect to the fence primitives in an implicit manner as discussed elsewhere herein. More specifically, the ordering of memory operations with respect to the fence primitives is conveyed from one memory system phase 302 to the next memory system phase 302 via the ordering in which memory operations are actually transmitted between memory system phases 302 with respect to fence primitives. A memory system phase 302 indicates to a subsequent memory system phase 302 that a memory operation is older than a fence primitive by transmitting the memory operation before the fence primitive. A memory system phase 302 indicates to a subsequent memory system phase 302 that a memory operation is younger than a fence primitive by transmitting the fence primitive before the memory operation. It should be understood that although an implicit technique for indicating memory operation ordering with respect to fence primitives is shown in FIGS. 4A-4G, an explicit technique, in which the memory operation execution system 300 indicates ordering of memory operations with respect to fence primitives via explicit ordering information, and in which memory operations do not need to be transmitted between memory system phases 302 in an ordered manner with respect to fence primitives is also contemplated.

In addition, throughout FIGS. 4A-4G, load/store operations are illustrated as proceeding through the memory system phases 302 of a memory system 301. Where the figures show a particular operation, such as load/store operation 1, being forwarded to different stages of the memory operation execution system 300, this should be understood as each stage receiving the load/store operation, processing that operation, and issuing that operation to the next memory system phase 302. In an example, load/store unit 214 issues load/store operation 1 to memory system phase 1 302(1). Memory system phase 1 302(1) processes load/store operation 1 and issues that operation to memory system phase 2 302(2).

Although not illustrated in FIGS. 4A-4G, it is possible for a memory operation to be “completed” (e.g., for a hit to occur instead of a miss) at a particular memory system phase 302. In that scenario, the memory operation is not transmitted to subsequent memory system phases 302 and ordering at those subsequent memory system phases 302 is performed without consideration for the memory operation that has completed.

In the example of FIG. 4A, a load/store unit 214 transmits memory operation 1 to memory system phase 1 302(1). In FIG. 4B, memory system phase 1 302(1) is processing memory operation 1 and receives memory operation 2. In FIG. 4C, memory system phase 1 302(1) is processing memory operation 1 and memory operation 2 and receives a fence primitive which is younger than memory operations 1 and 2 in program order. In FIG. 4D, the load/store unit 214 issues memory operation 3 to the memory system phase 1 302(1). In addition, memory system phase 1 302(1) has completed memory operation 2 and thus forwards memory operation 2 to memory system phase 2 302(2).

Because the fence primitive is younger than memory operation 2, memory system phase 1 302(1) allows memory operation 2 to issue without waiting for the fence primitive to issue to the subsequent stages. However, memory operation 3 is younger than the fence primitive and thus memory operation 3 is not issued to memory system phase 2 until the fence primitive is issued to memory system phase 2 302(2).

In FIG. 4E, memory system phase 1 302(1) is still processing memory operation 1 and has not yet issued memory operation 1 to subsequent memory system phases 302. Therefore, memory system phase 1 has not yet issued the fence primitive or operations younger than the fence primitive to subsequent memory system phases 302. Note that in FIG. 4E, memory operation 3 is complete.

At FIG. 4F, memory system phase 1 302(1) has completed memory operation 1 and therefore memory system phase 1 302(1) issues memory operation 1 to memory system phase 2 302(2). At this point, there are no operations at memory system phase 1 302(1) older than the fence primitive that have not yet issued been issued to subsequent memory system phases 302. For this reason, memory system phase 1 302(1) issues the fence primitive to the subsequent memory system phase 302.

In FIG. 4G, memory system phase 1 302(1) issues memory operation 3 to memory system phase 2 302(2). This act is allowed in FIG. 4G because all fence primitives older than memory operation 3 are issued to memory system phase 2 302(2).

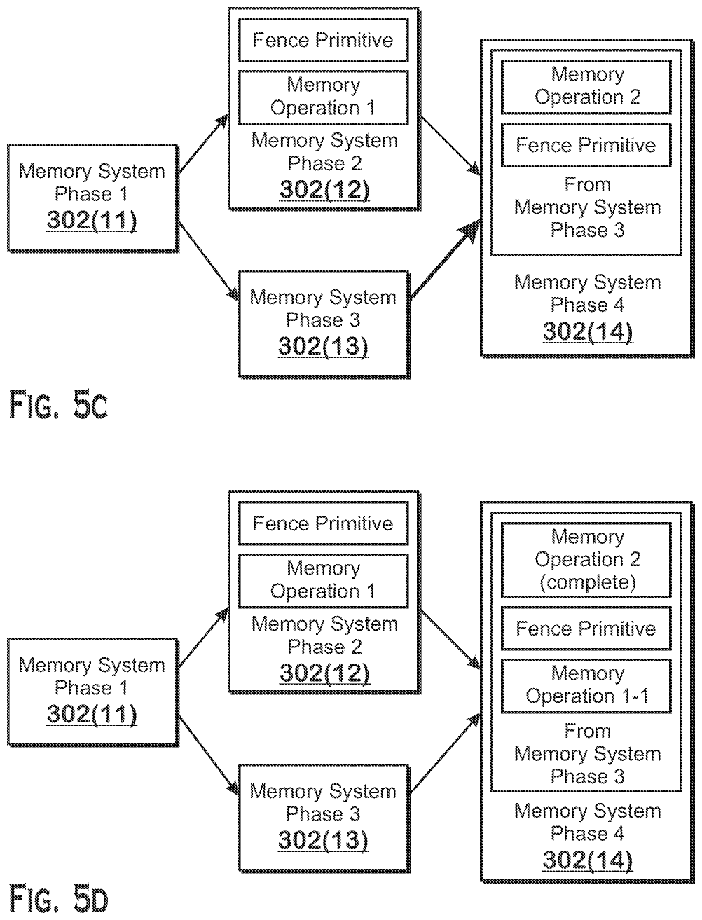

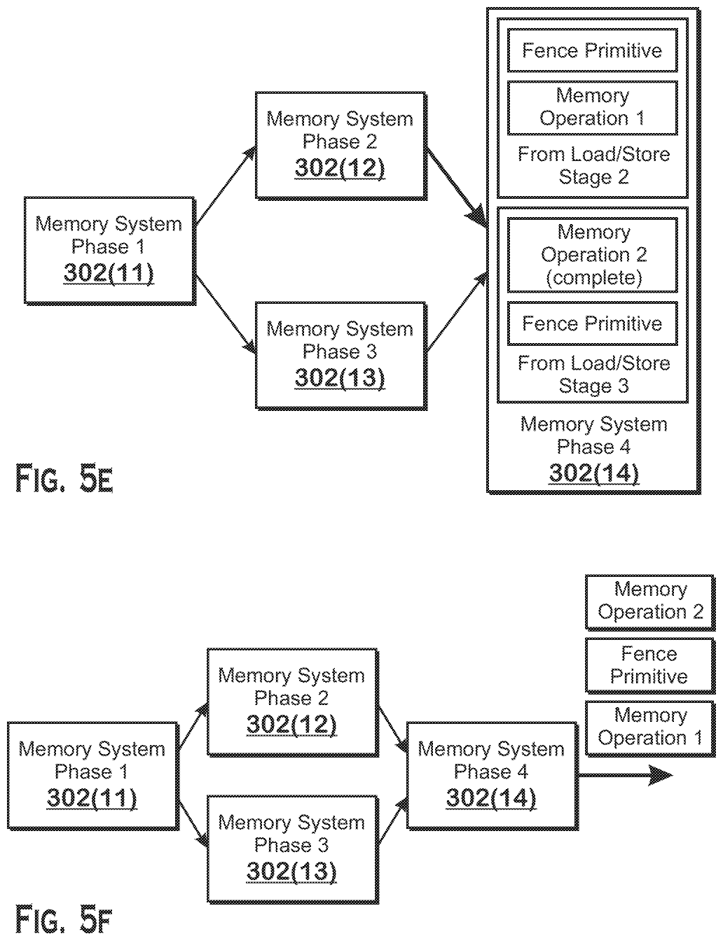

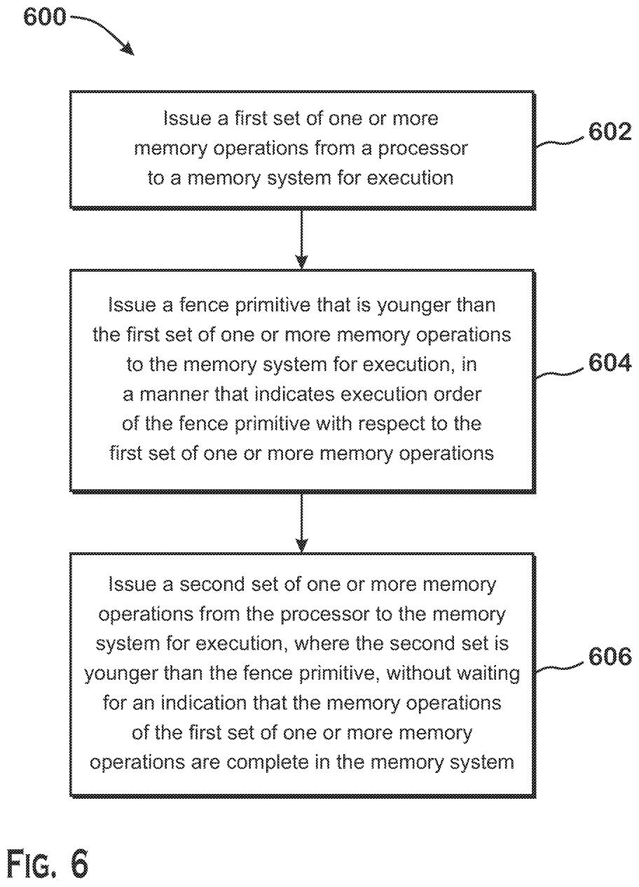

FIGS. 5A-5F illustrate an example of processing memory operations at memory system phases that include a branching path and a branch reconvergence stage. In any particular figure, bolded arrows from one stage 302 to another stage 302 indicate that one or more operations and/or one or more fence primitives have been transmitted according to the arrow in the operations of that figure. In addition, the memory system phases of these figures include memory system phase 1 302(11), which branches to both memory system phase 2 302(12) and memory system phase 3 302(13). Memory system phase 2 302(12) and memory system phase 3 302(13) reconverge at memory system phase 4 302(14). It should be understood that FIGS. 5A-5F do not necessarily illustrate all phases 302 of the example memory system depicted. The operations illustrated in FIGS. 5A-5F communicate ordering information implicitly as described elsewhere herein. However, alternatives of the branch and reconvergence technique where ordering information is communicated explicitly are also contemplated by the present disclosure.

In FIG. 5A, memory system phase 1 receives operations including memory operation 1, a fence primitive, and memory operation 2. Memory operation 1 is older than the fence primitive and memory operation 2 is younger than the fence primitive.

In FIG. 5B, the memory system phase 1 302(11) has completed the operations and has transmitted these operations and the fence primitive to two subsequent stages, memory system phase 2 302(12) and memory system phase 3 302(13). Memory operation 2 does not have to be executed at memory system phase 2 302(12), which is why memory operation 2 is not shown at memory system phase 2 302(12). However, memory operation 2 is to execute at memory system phase 3 302(13), and such operation is therefore shown at memory system phase 3 302(13).

Memory operation 1 is to execute at memory system phase 2 302(12). As described elsewhere herein, the fence primitive is transmitted to each memory system phase 302 that receives operations at a branch point (for example, to each stage 302 that is immediately subsequent to a stage that already has a fence primitives). Thus memory system phase 1 302(11) transmits the fence primitive to both memory system phase 2 302(12) and memory system phase 3 302(13). In some implementations, fence primitive copying circuitry at the memory system phase 302 that transmits multiple fence primitives, generates the multiple fence primitives for transmission to the memory system phases 302 that receive those fence primitives. Memory system phase 2 302(12) performs memory operation 1 in a manner that appears to software as if that memory operation executes before any memory operations younger than the fence primitive. At memory system phase 3 302(13), even though there is a fence primitive, there are no memory operations older than the fence primitive, and so memory system phase 3 302(13) is free to execute memory operation 2 without regard to execution ordering constraints, at least with respect to the fence primitive shown.

In FIG. 5C, memory system phase 3 302(13) has completed memory operation 2. Thus memory system phase 3 302(13) transmits memory operation 2 to memory system phase 4 302(14). Memory system phase 3 302(13) also transmits the fence primitive to memory system phase 4 302(14). Upon receiving the fence primitive, memory system phase 4 302(14) notes that the fence primitive is a fence primitive copy, since that fence primitive was copied by memory system phase 1 302(11) and such copies were transmitted to memory system phase 2 302(12) and memory system phase 3 302(13). Therefore, memory system phase 4 302(14) does not allow any operations younger than the fence primitive to be transmitted to any subsequent stage at least until all fence primitive copies have been received and reconverged into a reconverged fence primitive, and that reconverged fence primitive has been transmitted to a subsequent memory system phase 302. Memory system phase 4 302(14) does not allow the reconverged fence primitive to be transmitted to any subsequent stage 302 until all memory operations older than the fence primitive copies have been issued to subsequent memory system phase 302. One such operation—memory operation 1—is still at memory system phase 2 302(12) and is thus not complete at memory system phase 4 302(14).

In FIG. 5D, memory system phase 4 302(14) has completed memory operation 2. However, memory system phase 4 302(14) is not permitted to, and does not, issue memory operation 2 to any subsequent memory system phase 302, since the fence primitive cannot be issued to any subsequent memory system phase 302 yet. Memory system phase 2 302(12) has not completed memory operation 1, and therefore has not issued that operation to memory system phase 4 302(14). In some implementations, a reconvergence phase defers processing of any younger memory operations until all copies of the fence have arrived at the reconvergence phase. In such a case, processing of memory operation 2 is deferred until the other copy of the fence arrives at phase 4 in this example.

In FIG. 5E, memory system phase 2 302(12) completes memory operation 1, and therefore issues memory operation 1, as well as the fence primitive, to memory system phase 4 302(14). In FIG. 5F, memory system phase 4 completes all memory operations shown. Since memory operation 1 is complete, memory system phase 4 302(14) issues memory operation 1 to a subsequent unit. Additionally, since these operations are the only operations older than the fence primitive, and thus all memory operations older than the fence primitive have issued to subsequent memory system phases 302, memory system phase 4 302(14) issues the combined fence primitive to subsequent memory system phases 302. Additionally, since memory operation 2 is complete, and all fence primitives older than memory operation 2 have been issued to subsequent memory system phases 302, memory system phase 4 302(14) issues memory operation 2 to subsequent memory system phases 302.

In some implementations, in response to a branch reconvergence point receiving a fence primitive copy, one or more previous memory system phases 302 that hold the other fence primitive copies prioritize work that would allow those copies to be transmitted to the branch reconvergence point.

FIG. 6 is a flow diagram of a method 600 for ordering memory operations according to a fence primitive, according to an example. Although described with respect to the system of FIGS. 1-5F, those of skill in the art will understand that any system that performs the steps of the method 600 in any technically feasible order falls within the scope of the present disclosure.

At step 602, a processor 200 issues a first set of one or more memory operations to a memory system 301 for execution. The first set of one or more memory operations include such operations as load operations that read data from the memory system 301 and store operations that write data to the memory system 301.

At step 604, the processor 200 issues a fence primitive to the memory system 301. The fence primitive is younger than the first set of memory operations. The processor 200 issues the fence primitive to the memory system 301 in a manner that indicates the execution order of the fence primitive relative to the first set of memory operations. In one example, this ordering is indicated implicitly, by issuing the fence primitive to the memory system 301 after issuing the first set of memory operations, thereby indicating that the first set of memory operations is older than the fence primitive. In another example, this ordering is indicated explicitly, by providing explicit information that indicates that the fence primitive is younger than each instruction of the first set of instructions. In one example implementation, each fence primitive is assigned a group number. Each memory operation is assigned a group number as well. Each group is the group of memory operations between fence primitives. Thus a group number identifies a group of memory operations between two fence primitives. Different group numbers thus identify different groups of memory operations. In one example, a higher group number indicates younger memory operations. The fence primitive is also transmitted with a count of the number of memory operations in the associated group so that the phases 302 of the memory system know how many operations to wait for when a fence primitive is received.

At step 606, the processor 200 issues a second set of one or more memory operations to the memory system 301 for execution. The second set of one or more memory operations is younger than the fence primitive (and thus the first set of one or more memory operations). Therefore, the memory system 301 should execute the first set and the second set in a manner that appears to software as if all operations of the first set complete before all operations of the second set. As described elsewhere herein, this “appearance” means that software executing on the processor 200 is unable to determine that any improper ordering occurs even if certain aspects of the first set and the second set actually are performed in a manner that is not in line with the order imposed by the fence primitive. The processor 200 issues the second set of memory operations to the memory system 301 for execution without waiting for an indication from the memory system 301 that the memory operations of the first set are complete.

As described elsewhere herein, a different technique for ordering memory operations according to a fence involves issuing operations older than the fence to the memory system 301. When a fence is then encountered, the processor waits to issue memory operations younger than the fence to the memory system 301 until the processor 200 has received an indication that all memory operations older than the fence are completed. An operation older than the fence is complete when a hit occurs in one of the memory system phases.

With the technique provided herein, wherein each phase 302 of the memory system 301 receives ordering information, the processor 200 does not wait for such completion indications before issuing memory operation after a fence. The phases 302 are able to perform the ordering themselves using the ordering information. As described elsewhere herein, the ordering information is provided in explicit form (i.e., as tags that directly specify the ordering of memory operations with respect to fence primitives) or in implicit form (i.e., through the order in which memory operations are transmitted between phases 302 with respect to the fence primitives). Each phase 302 enforces ordering by internally processing the received operations in a manner that respects the fence ordering and by issuing operations and fence primitives to a subsequent phase 302 in a manner that indicates the ordering with respect to the fence primitives. Again, this information may be implicit ordering information or explicit ordering information.

In some situations, at least one of the memory system phases 302 is a branch point that issues operations to multiple immediately subsequent memory system phases 302. For such a memory system phase, at step 604, the memory system phase issues a copy of the fence primitive to each memory system phase 302 that is immediately subsequent to the branch point stage.

As described elsewhere herein, it is possible for a fence primitive to define a point in the memory system 301 (e.g., a specific phase 302) that is the limit of where fence-based ordering is enforced. Phases 302 past that point do not enforce the ordering and phases 302 prior to that point do enforce the ordering.

In some situations, at least one of the memory system phases 302 is a branch reconvergence point, which is a stage 302 that receives operations from multiple immediately previous memory system phases 302. For such a memory system phase 302, step 604 is executed by waiting until all fence primitive copies have been received from all immediately previous memory system phases 302 and recombined back into a single fence primitive. The branch reconvergence point then has enough information to order memory operations from previous paths with respect to received fence primitives.

It is possible for any of the fence primitives described herein, including with respect to FIG. 6, to be a fence primitive of different types. The term “type” describes what type (e.g., load or store or both) of memory operation is waited on (i.e., older than the fence primitive) and what type of memory operation waits for the fence primitive (i.e., younger than the fence primitive). For example, for a load-after-load fence primitive, the fence primitive does not enforce ordering with respect to store operations. In other examples, fence primitives of other types, such as load-after-store, store-after-load, or store-after-store, are used.

It should be understood that many variations are possible based on the disclosure herein. Although features and elements are described above in particular combinations, each feature or element may be used alone without the other features and elements or in various combinations with or without other features and elements.

The various functional units illustrated in the figures and/or described herein (including, where appropriate, the processor 102, the input driver 112, the input devices 108, the output driver 114, the output devices 110, the instruction cache 202, the instruction fetch unit 204, the decoder 208, the retire queue 210, the reservation stations 212, the data cache 220, the load/store unit 214, the functional units 216, the register file 218, the common data bus 222, the memory system 301 and memory system phases 302) may be implemented as hardware circuitry, software executing on a programmable processor, or a combination of hardware and software. The methods provided may be implemented in a general purpose computer, a processor, or a processor core. Suitable processors include, by way of example, a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing memory operations comprising:
issuing, by a processor, a fence primitive to a memory system, the fence primitive issued in a manner that indicates a program order of memory operation execution.

2. The method of claim 1, further comprising:
issuing a first set of memory operations and a second set of memory operations to the memory system, the second set of memory operations being younger than the first set of memory operations, wherein the fence primitive indicates relative program order of the first set of memory operations with respect to the fence and to the second set of memory operations.

3. The method of claim 2, wherein:
the fence primitive is younger than the first set of memory operations; and
the processor does not wait for an indication that the memory operations of the first set of memory operations are complete in the memory system before issuing the second set of memory operations to the memory system for execution.

4. The method of claim 2, wherein a phase of the memory system enforces ordering imposed by the fence primitive by preventing memory operations of the second set from appearing to software to execute before memory operations of the first set.

5. The method of claim 2, wherein a phase of the memory system issues the first set, the fence primitive, and the second set to a subsequent phase of the memory system in a manner that indicates program order of the fence primitive with respect to the first set and the second set.

6. The method of claim 2, wherein the fence primitive is issued with explicit information that indicates the execution order of the fence primitive with respect to the first set of memory operations.

7. The method of claim 6, wherein the explicit information comprises a group identification issued with the fence primitive, wherein the group identification identifies the first set as being older than the fence primitive.

8. The method of claim 7, wherein the operations of the first set are transmitted to the memory system with a group identification identifying the operations as part of a first group that is older than the fence primitive.

9. The method of claim 2, wherein the first set, the second set, and the fence primitive are issued to the memory system in an order that indicates that the first set is older than the fence primitive and that the second set is younger than the fence primitive.

10. The method of claim 2, wherein:
a phase of the memory system comprises a branch point having two subsequent memory system phases; and
the phase transmits the fence primitive to both of the two subsequent memory system phases.

11. The method of claim 10, wherein the memory system further comprises a branch reconvergence point configured to:
receive the fence primitive from both of the two subsequent memory system phases; and
execute the first set and the second set in order with respect to the fence primitive received from both of the two subsequent memory system phases.

12. The method of claim 1, wherein the fence primitive specifies a last phase of the memory system that enforces the ordering of the fence primitive.

13. A system, comprising:
a processor; and
a memory system,
wherein the processor is configured to:
issue a fence primitive to the memory system, the fence primitive issued in a manner that indicates a program order of memory operation execution.

14. The system of claim 13, wherein the processor is further configured to:
issue a first set of memory operations and a second set of memory operations to the memory system, the second set of memory operations being younger than the first set of memory operations, wherein the fence primitive indicates relative program order of the first set of memory operations with respect to the fence and to the second set of memory operations.

15. The system of claim 14, wherein:
the fence primitive is younger than the first set of memory operations; and
the processor is configured not to wait for an indication that the memory operations of the first set of memory operations are complete in the memory system before issuing the second set of memory operations to the memory system for execution.

16. The system of claim 14, wherein a phase of the memory system enforces ordering imposed by the fence primitive by preventing memory operations of the second set from appearing to software to execute before memory operations of the first set.

17. The system of claim 14, wherein a phase of the memory system issues the first set, the fence primitive, and the second set to a subsequent phase of the memory system in a manner that indicates program order of the fence primitive with respect to the first set and the second set.

18. The system of claim 14, wherein the fence primitive is issued with explicit information that indicates the execution order of the fence primitive with respect to the first set of one or more memory operations.

19. The system of claim 18, wherein the explicit information comprises a group identification issued with the fence primitive, wherein the group identification identifies the first set as being older than the fence primitive.

20. The system of claim 19, wherein the operations of the first set are transmitted to the memory system with a group identification identifying the operations as part of a first group that is older than the fence primitive.

21. The system of claim 14, wherein the first set, the second set, and the fence primitive are issued to the memory system in an order that indicates that the first set is older than the fence primitive and that the second set is younger than the fence primitive.

22. The system of claim 14, wherein:
a phase of the memory system comprises a branch point having two subsequent memory system phases; and
the phase transmits the fence primitive to both of the two subsequent memory system phases.

23. The system of claim 22, wherein the memory system further comprises a branch reconvergence point configured to:
receive the fence primitive from both of the two subsequent memory system phases; and
execute the first set and the second set in order with respect to the fence primitive received from both of the two subsequent memory system phases.

24. The system of claim 13, wherein the fence primitive specifies a last phase of the memory system that enforces the ordering of the fence primitive.

25. A processor, configured to:
issue a fence primitive to a memory system, the fence primitive issued in a manner that indicates a program order of memory operation execution.

26. The processor of claim 25, further configured to:
issue a first set of memory operations and a second set of memory operations to the memory system, the second set of memory operations being younger than the first set of memory operations, wherein the fence primitive indicates relative program order of the first set of memory operations with respect to the fence and to the second set of memory operations.

27. The processor of claim 26, wherein:
the fence primitive is younger than the first set of memory operations; and
the processor is configured not to wait for an indication that the memory operations of the first set of memory operations are complete in the memory system before issuing the second set of memory operations to the memory system for execution.

28. The processor of claim 26, wherein the fence primitive is issued with explicit information that indicates the execution order of the fence primitive with respect to the first set of one or more memory operations.

29. The processor of claim 28, wherein the explicit information comprises a group identification issued with the fence primitive, wherein the group identification identifies the first set as being older than the fence primitive.

30. The processor of claim 29, wherein the operations of the first set are transmitted to the memory system with a group identification identifying the operations as part of a first group that is older than the fence primitive.

31. The processor of claim 26, wherein the first set, the second set, and the fence primitive are issued to the memory system in an order that indicates that the first set is older than the fence primitive and that the second set is younger than the fence primitive.
